(19) United States
(12) Patent Application Publication
(10) Pub. No.: US 2008/0278802 A1
(43) Pub. Date: Nov. 13, 2008

(54) Side Aperture telescope mount

(76) Inventor: Dante Duby, El Cajon, CA (US)

Correspondence Address: Dante Duby, P. O. Box 1560, El Cajon, CA, 92019, US

(21) Appl. No.: 12/220,197

(22) Filed: Jul. 21, 2008

Related U.S. Application Data
(63) Continuation-in-part of application No. 11/463,282, filed on Aug. 8, 2006, now Pat. No. 7,403,331.

(51) Int. Cl. G02B 23/16

(52) U.S. Cl. 359/429

(57) ABSTRACT

A telescope mount with a fixed vertical axis of rotation, a fixed horizontal axis of rotation, and a variable axis of rotation. The mount allows a side aperture telescope to simultaneously rotate horizontally and vertically while also allowing the telescope to be tilted up and down.

This is a continuation in part to application Ser. No. 11/463,282 filed Aug. 8, 2006.

### BACKGROUND OF THE INVENTION

The present invention relates to telescope mounts, more specifically to a special type of telescope mount used by side aperture telescopes such as that shown in my co-pending application. This mount has multiple degrees of freedom to accommodate the additional range of motion requirements of a side aperture telescope and can easily be used in either a horizontal or vertical manner depending on individual comfort preferences and telescope size.

One object of the invention is to provide a telescope mount that can be used with a very specific type of telescope with a side aperture that can operate either horizontally mounted or vertically mounted. The vast majority of telescope mounts are intended for telescopes that are pointed up and down by tilting the telescope in the mount. That is insufficient for a telescope that can either be tilted to point up and down, or rotated to point up and down. Therefore an additional rotational axis was required to service that feature. The advantage of the added rotational axis is that the telescope can be rotated to point up and down when it is tilted back in the mount or sitting horizontally in the mount.

These and other objects and advantages of the present invention will become increasingly apparent upon consideration of the drawings and ensuing description.

### PRIOR ART

There are many telescope mounts available today but they are designed for telescopes that have their opening aperture at one end of the telescope or the other rather than having the opening aperture on the side of the telescope as is the case with my co-pending telescope application. Therefore, these other mounts don't have to accommodate the possibility of the side aperture telescope needing to be rotated both horizontally and vertically at the same time.

### SUMMARY OF THE INVENTION

The present invention is a telescope mount which allows a side aperture telescope to simultaneously rotate horizontally and vertically while also allowing the telescope to be tilted up and down.

### DESCRIPTION OF THE DRAWINGS

FIG. 1 shows a side view of the telescope mount with a horizontally mounted side aperture telescope pointed straight up.

FIG. 2 shows a side view of the telescope mount with a horizontally mounted side aperture telescope pointed to the side.

FIG. 3 shows a front view of the telescope mount with a vertically mounted side aperture telescope pointed straight ahead.

FIG. 4 shows a side view of the telescope mount with a vertically mounted side aperture telescope pointed to the side.

FIG. 5 shows a side view of the telescope mount with a vertically mounted side aperture telescope pointed up at an angle due to tilting it back in the mount.

### DETAILED DESCRIPTION OF THE PREFERRED EMBODIMENT

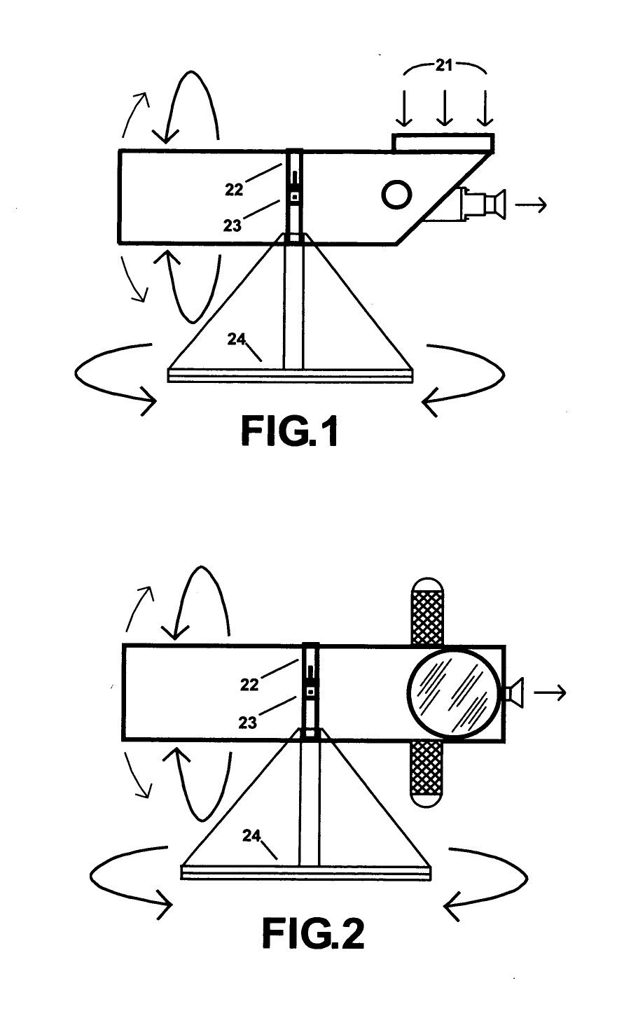

Referring to the drawings for a more detailed explanation of the preferred form of the invention, FIG. 1 shows the telescope mount used with a horizontally mounted side aperture telescope pointing straight up; as indicated by light entering the telescope aperture 21 and exiting the telescope eyepiece to the right. The fixed vertical axis, 24, allows the telescope to rotate about a vertical axis through the center of the mount; as indicated by the curved arrows near the base of the mount. This makes it possible for the telescope to point 360° about the vertical axis. The fixed horizontal axis, 23, allows the telescope to be tilted up and down at least 0° to 90° in a forward/backward manner; as indicated by up and down arrows at the bottom of the mounted telescope. The variable axis, 22, allows the telescope to point at least 0° to 180° in a side to side manner; as indicated by curved arrows about the telescope tube.

FIG. 2 shows the telescope mount used with a horizontally mounted side aperture telescope pointing to the side. The fixed vertical axis, 24, allows the telescope to rotate about a vertical axis through the center of the mount. This makes it possible for the telescope to point 360° about the vertical axis. The fixed horizontal axis, 23, allows the telescope to be tilted up and down at least 0° to 90° in a forward/backward manner. The variable axis, 22, allows the telescope to point at least 0° to 180° in a side to side manner.

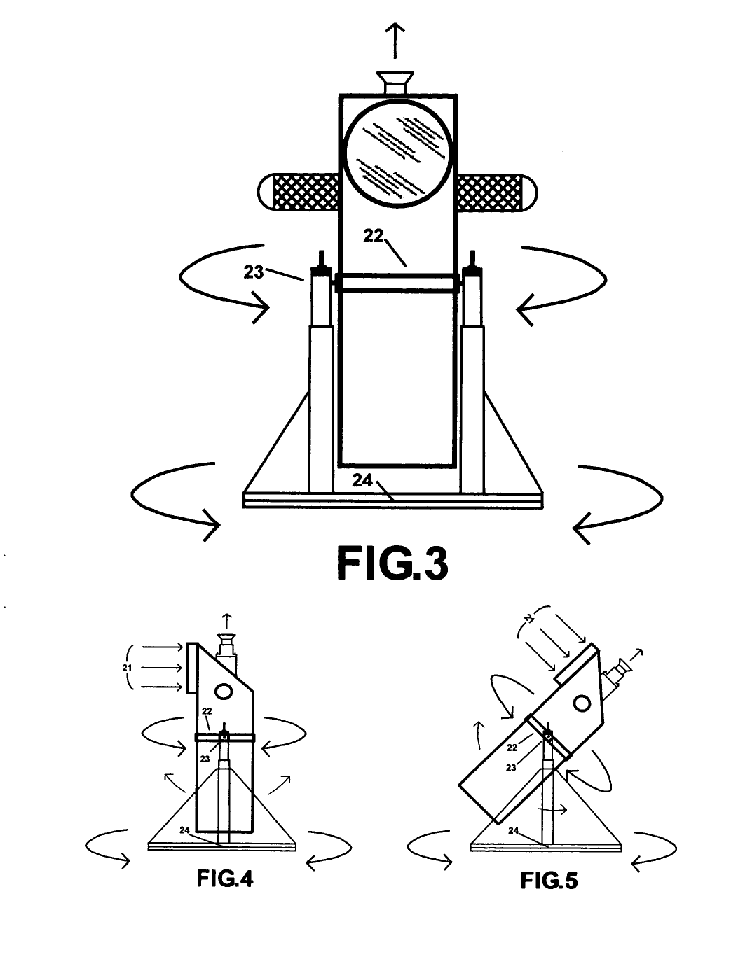

FIG. 3 shows the telescope mount used with a vertically mounted side aperture telescope pointing straight ahead. The fixed vertical axis, 24, allows the telescope to rotate about a vertical axis through the center of the mount. This makes it possible for the telescope to point 360° about the vertical axis. The fixed horizontal axis, 23, allows the telescope to be tilted up and down at least 0° to 90° in a forward/backward manner. The variable axis, 22, allows the telescope to point from 0° to 360° in a side to side manner. When completely vertical, either axis 24 or axis 22 can function to allow the telescope to rotate about the vertical axis.

FIG. 4 shows the telescope mount used with a vertically mounted side aperture telescope pointing straight to the side. The fixed vertical axis, 24, allows the telescope to rotate about a vertical axis through the center of the mount. This makes it possible for the telescope to point 360° about the vertical axis. The fixed horizontal axis, 23, allows the telescope to be tilted up and down at least 0° to 90° in a forward/backward manner. The variable axis, 22, allows the telescope to point 0° to 360° in a side to side manner.

FIG. 5 shows the telescope mount used with a vertically mounted side aperture telescope pointing to the side and tilted back at some angle with respect to vertical. The fixed vertical axis, 24, allows the telescope to rotate about a vertical axis through the center of the mount. This makes it possible for the telescope to point 360° about the vertical axis. The fixed horizontal axis, 23, allows the telescope to be tilted up and down at least 0° to 90° in a forward/backward manner. The variable axis, 22, allows the telescope to point at least 0° to 180° in a side to side manner.

Operation of the telescope mount is fairly straightforward and is essentially the same for each telescope orientation. Considering a horizontal mount orientation, the user could sit in a chair with the eyepiece at a comfortable viewing level. For viewing different overhead angles in celestial use, the telescope would simply be rotated within its mount about the telescope tube, 22. An electrical motor or similar means could also rotate the telescope in this way. The eyepiece would remain in the exact same location through 180° of revolution. For viewing different landscape directions, the telescope would be rotated in the base of the mount, 24. For minor overhead variation the telescope could be tilted up or down with the horizontal mount axis, 23.

Considering a vertically mounted telescope orientation, the user could be standing or sitting dependent on the eyepiece configuration. The only differences would be in the directional changes of view. For viewing different overhead angles in celestial use the telescope would be tilted back in its horizontal mount, 23. For viewing different landscape directions, the telescope would simply be rotated within its mount about the telescope tube, 22, or mount base, 24.

It may be apparent that any telescope which is small enough to be used in a vertical orientation can also be used in the horizontal orientation just by tilting it back to a horizontal position and using as previously described.

I claim:

1. A telescope mount comprising:
(a) a fixed vertical axis of rotation,
(b) a fixed horizontal axis of rotation,
(c) a variable axis of rotation, and
(d) a means for attaching a telescope to the mount,
(e) where said means for attaching a telescope provides a way to mount the telescope to the variable axis of rotation,
(f) where said variable axis of rotation is mounted to said horizontal axis of rotation,
(g) where said horizontal axis of rotation is mounted to said vertical axis of rotation,
(g) where said vertical axis of rotation provides a means to rotate the entire telescope mount about the vertical axis.

2. A telescope mount comprising:
(a) a fixed vertical axis of rotation,
(b) a fixed horizontal axis of rotation,
(c) a variable axis of rotation, and
(d) a means for attaching a telescope to the mount,
(e) with said vertical axis of rotation providing rotation about the vertical axis for both the said horizontal axis of rotation and said variable axis of rotation,
(f) where said horizontal axis of rotation provides horizontal axis rotation for said variable axis of rotation,
(g) where said variable axis of rotation provides a variable axis of rotation for a mounted telescope about its length.
(h) where said means for attaching a telescope provides a means for mounting the telescope to the variable axis of rotation.
